(19) United States
(12) Patent Application Publication
(10) Pub. No.: US 2026/0288379 A1
(43) Pub. Date: Sep. 24, 2026

(54) BUFFERING FORCE UNIT ACCESS COMMANDS FOR BOOT-UP PROCEDURES

(71) Applicant: Micron Technology, Inc., Boise, ID (US)

(72) Inventors: Roberto Izzi, Caserta (IT); Nicola Colella, Capodrise (CE) (IT); Rakeshkumar Dayabhai Vaghasiya, Hyderabad (IN); Komuravelli Vamshikrishna, Hyderabad (IN)

(21) Appl. No.: 19/557,879

(22) Filed: Mar. 5, 2026

Related U.S. Application Data
(60) Provisional application No. 63/774,650, filed on Mar. 19, 2025.

(51) Int. Cl. G06F 3/06

(52) U.S. Cl. CPC G06F 3/0659; G06F 3/0619; G06F 3/0679

(57) ABSTRACT

Methods, systems, and devices for buffering force unit access commands for boot-up procedures are described. Techniques described herein may enable a memory system to delay writing data associated with force unit access (FUA) commands to a non-volatile memory until a trigger condition is satisfied. That is, the memory system may store data associated with each FUA command in a buffer until reception of a last FUA command of a set of FUA commands in the boot-up procedure. The memory system may write the data associated with each FUA command to the non-volatile memory after the trigger is satisfied. In some examples, the memory system may indicate, to the host system, that the data has been written to the non-volatile memory prior to writing the data to the non-volatile memory.

### CROSS REFERENCE

The present Application for Patent claims priority to U.S. Patent Application No. 63/774,650 by Izzi et al., entitled “BUFFERING FORCE UNIT ACCESS COMMANDS FOR BOOT-UP PROCEDURES,” filed Mar. 19, 2025, which is assigned to the assignee hereof, and which is expressly incorporated by reference in its entirety herein.

### TECHNICAL FIELD

The following relates to one or more systems for memory, including buffering force unit access commands for boot-up procedures.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports buffering force unit access (FUA) commands for boot-up procedures in accordance with examples as disclosed herein.

FIG. 2 shows an example of a process flow that supports buffering FUA commands for boot-up procedures in accordance with examples as disclosed herein.

FIG. 3 shows a block diagram of a memory system that supports buffering FUA commands for boot-up procedures in accordance with examples as disclosed herein.

FIG. 4 shows a flowchart illustrating a method or methods that support buffering FUA commands for boot-up procedures in accordance with examples as disclosed herein.

### DETAILED DESCRIPTION

In some examples, a memory system (e.g., an automotive system) may receive one or more force unit access (FUA) write commands from a host system during a boot-up procedure. In such examples, the FUA commands may trigger the memory system to write data (e.g., boot-up data, data associated with the FUA commands) to a non-volatile memory (e.g., a not-and (NAND) memory) immediately upon receiving the FUA write commands. Such techniques may result in increased latency associated with the boot-up procedure as a result of writing the data to the non-volatile memory prior to performing one or more other operations of the boot-up procedure. In automotive environments, it may be useful to reduce a duration for boot-up of a memory system as much as possible. For example, a vehicle may be started and there may be a delay between starting the engine and some electronics becoming active, such as the back-up camera. Some of the delay in the back-up camera becoming active may be due to a duration for boot-up of a system in the vehicle (e.g., a boot-up procedure for the system may include operations performed by a memory system of the vehicle).

Accordingly, techniques described herein may enable the memory system to delay writing the data to the non-volatile memory until a trigger during a boot-up procedure. For example, a memory system may receive a set of FUA commands, buffering the data for a threshold period of time, and then write the data to NAND to improve the latency of the boot-up procedure. That is, the memory system may store data associated with each FUA command in a buffer (e.g., a static random access memory (SRAM) buffer, a volatile memory of the memory system) until reception of a last FUA command of a set of FUA commands in the boot-up procedure. The memory system may write the data associated with each FUA command to the non-volatile memory after the trigger is satisfied. In some examples, the memory system may indicate, to the host system, that the data has been written to the non-volatile memory prior to writing the data to the non-volatile memory. Such techniques may decrease a latency associated with the boot-up procedure.

In addition to applicability in memory systems as described herein, techniques for buffering FUA commands may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access and boot-up speeds, which may decrease processing or latency times, improve response times, or otherwise improve user experience, among other benefits.

Features of the disclosure are illustrated and described in the context of systems, devices, and circuits. Features of the disclosure are further illustrated and described in the context of process flows and flowcharts.

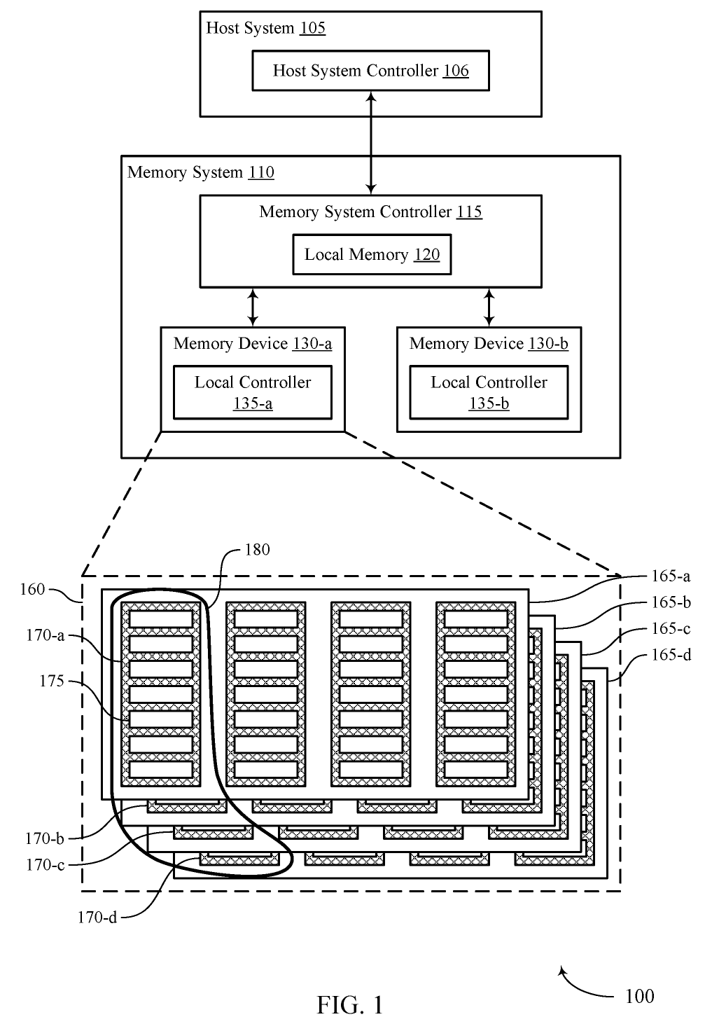

FIG. 1 shows an example of a system 100 that supports buffering FUA commands for boot-up procedures in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some examples of the system 100, a memory system 110 may delay writing data associated with FUA commands to a non-volatile memory of the memory system 110 until a trigger (e.g., receiving a last FUA command of a set of FUA commands, buffering the data for a threshold period of time, and the like). That is, the memory system 110 may store data associated with each FUA command in a buffer (e.g., a SRAM buffer, a volatile memory of the memory system 110) until reception of a last FUA command of a set of FUA commands in the boot-up procedure. The memory system 110 may write the data associated with each FUA command to the non-volatile memory after the trigger is satisfied. In some examples, the memory system may indicate, to the host system, that the data has been written to the non-volatile memory prior to writing the data to the non-volatile memory. Such techniques may decrease a latency associated with the boot-up procedure.

The system 100 may include any quantity of non-transitory computer readable media that support buffering FUA commands for boot-up procedures. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

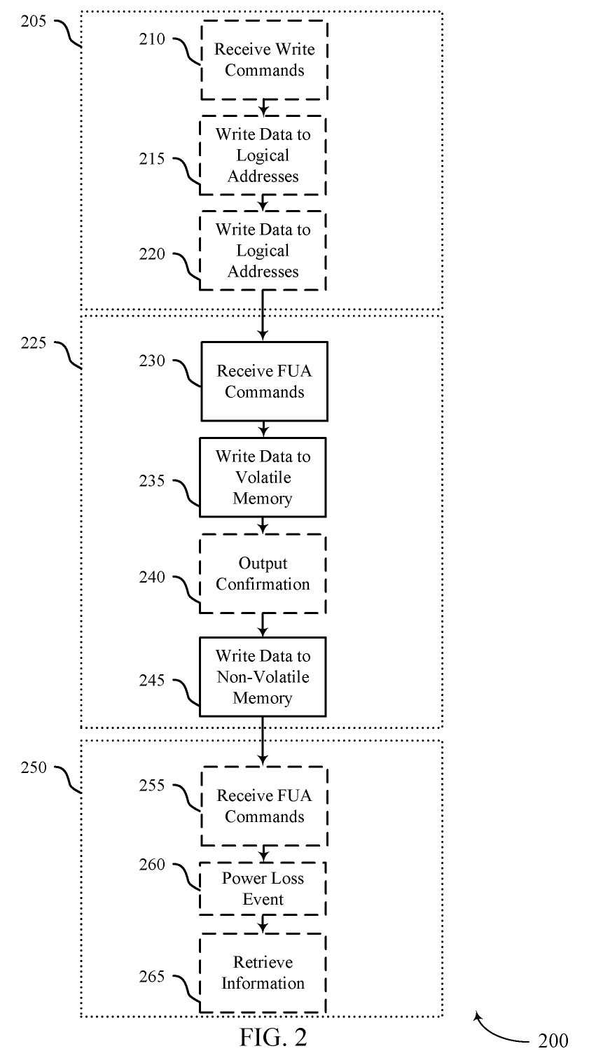

FIG. 2 shows an example of a process flow 200 that supports buffering FUA commands for boot-up procedures in accordance with examples as disclosed herein. The process flow 200 may implement or may be implemented by aspects of the system 100. For example, the process flow 200 may be implemented by a memory system 110 (and a host system 105, which may be examples of the corresponding devices as described with reference to FIG. 1.

In the following description of the process flow 200, the operations may occur in a different order than the example order shown and, in some examples, may be performed by one or more different devices other than those shown as examples. Some operations also may be omitted from the process flow 200, and other operations may be added to the process flow 200. Further, although some operations or signaling may be shown to occur at different times for discussion purposes, these operations may actually occur at the same time.

Aspects of the process flow 200 may be implemented by one or more controllers, among other components. Additionally or alternatively, aspects of the process flow 200 may be implemented as instructions stored in one or more memories (e.g., firmware stored in one or more memories coupled with a memory system). For example, the instructions, when executed by one or more controllers (e.g., a memory controller, a local controller), may cause the one or more controllers (or a device or a system) to perform the operations of the process flow 200.

In some examples, a memory system 110 may receive one or more FUA commands from a host system 105 as part of a boot-up procedure for a system (e.g., a vehicle system). In some examples, one or more operations of the boot-up procedure described herein may be performed by the memory system 110 (e.g., a memory controller of the memory system 110). A FUA command may refer to a specific type of command that requires the memory system 100 to write the data to a memory device 130 (e.g., a NAND memory device) before completing the command and not just write the data to the cache before completing the command. Examples of FUA commands may include write commands and read commands.

In some memory systems, a FUA command may be signaled by one or more bits in the command descriptor block (CDB) of the command. A CDB may include a command opcode and related parameters, one or more flags, and/or one or more attributes. In some cases, a command transaction between the host system 105 and memory system 110 may include a command, a data phase (optional), and a status phase. The command phase delivers the command information and supporting parameters from the host system 105 to the memory system 110. If a data phase is required, data flows between the host system 105 and the memory system 110 based on the type of command. For instance, data for a write command travels from the host system 105 to the memory system 110. Data for a read command travels from the memory system 110 to the host system 105. At the completion of the command, the memory system 110 will deliver a response to the host system 105 during the Status Phase. The response may include a response status indicating successful completion or failure of the command. In some examples, a write command may be an example of a FUA command if the one or more bits associated with the FUA indication in the CDB are in a first value (e.g., the FUA bit in the CDB is ‘1’).

In some systems, a memory system 110 may indicate that a write command is complete to the host system 105 after storing the data to the local memory 120 (e.g., the cache, SRAM). The memory system 110 may then write the data to the memory device 130 (e.g., NAND) at a later time. From the perspective of the host system 105, the write command was indicated as complete before the data associated with the write command was actually stored in the memory device 130. Such techniques may enable the memory system 110 to perform operations more efficiently. However, such techniques may lead to data loss in the event of a sudden power loss occurring or a reset occurring. For example, if data for a write command is stored in the cache and a power loss occurs, then that data will be lost. The host system 105 may have already discarded the data or otherwise changed it because the memory system 110 had already indicated that the command was completed.

A FUA command may be a way for a host system 105 to force a memory system 110 to write the data to the memory device 130 (e.g., NAND) before indicating that the command is complete. In this way, the risk of losing the data due to resetting or power loss is mitigated. During a boot-up procedure, however, ceasing other operations to perform a FUA command may increase the latency of the boot-up procedure. Further, boot-up procedures may include a large quantity of predictable and mostly static steps. Thus, there may not be as many advantages for FUA commands, as compared with more normal operations of the memory system 110.

In response to receiving a FUA command, the memory system 110 may pause other operations to immediately write the data associated with the FUA commands to a non-volatile memory (e.g., NAND) of the memory system 110. In such cases, the memory system 110 may indicate completion to the host system 105 after writing the data to the non-volatile memory (and not before writing to the non-volatile memory). By writing the data associated with the FUA commands immediately to the non-volatile memory, the memory system 110 may preserve the boot-up data in case of a power loss event during the boot-up procedure. However, such techniques may increase a latency associated with performing the boot-up procedure because other operations are interpreted.

Accordingly, techniques described herein may enable the memory system 110 to maintain a training log associated with a boot sequence such that a system (e.g., a vehicle system) including the memory system 110 may perform boot-up procedures without immediately writing the FUA command data to the non-volatile memory. The memory system 110 may accordingly refrain from writing the FUA command data to the non-volatile memory immediately after receiving the FUA commands, which may decrease latency associated with performing the boot-up procedure of the system.

At 205, a training procedure for the boot-up procedure may be performed. For examples, the system including the memory system 110 (e.g., a controller such as a memory system controller of the memory system) may perform the training procedure. For example, the system may perform a boot-up procedure as part of a training phase (e.g., a self-learning phase) in which the memory system 110 may collect information during the training phase. The memory system 110 may record the steps taken during the boot-up procedure and store those steps in a training log during a training phase. The memory system 110 may then use the recorded training log to pre-load boot data (e.g., in an SRAM space) during subsequent boot-up procedures. The subsequent boot-up procedures that use the training log to pre-fetch data from the NAND into the SRAM may be part of a replay phase. Using the training log to pre-fetch the data may result in relatively less latency and relatively improved boot performance as compared to boot-up procedures without a training phase and replay phase.

During one or more stages of the boot-up procedure (e.g., a primary boot loader (PBL) stage, an extensible boot loader (XBL) stage, and a unified extensible firmware interface (UEFI) stage), a command sequence may be relatively repeatable (e.g., the same) during a first boot-up procedure as during a subsequent boot-up procedure. Accordingly, the memory system 110 may capture and store the commands received during the first boot-up procedure (e.g., during the training phase) and may retrieve the commands during one or more subsequent boot-up procedures (e.g., during the replay phase). In some examples, booting up of the memory system 110 of the system may be complete following the PBL stage. The system may set a flag (e.g., a fDeviceINit flag) during the XBL stage. The memory system 110 may perform one or more operations to complete the boot-up procedure during the XBL stage and the UEFI stage.

For example, at 210, as part of the training procedure, a first set of write commands may be received during a boot-up procedure of system. For example, the memory system 110 may receive a first set of write commands from the host system 105. In some examples, the first set of write commands may be FUA commands (e.g., with a FUA enabled bit) or non-FUA write commands (e.g., without a FUA enabled bit). The first set of write commands may include data (e.g., data associated with the boot-up procedure), and may be associated with a set of logical addresses (e.g., LBAs). The memory system 110 may perform a tracking of the first set of write commands.

At 215, as part of the training procedure, the data may be written to non-volatile memory. For example, the memory system 110 (e.g., a memory system controller of the memory system) may write the data to the set of logical addresses of the memory system 110. The set of logical addresses may be associated with a non-volatile memory of the memory system 110. At 220, the memory system 110 may write the first set of commands and/or the set of logical addresses to a training log of the memory system.

At 225, a first boot-up procedure of the system may be performed. For example, the memory system 110 (e.g., a memory system controller of the memory system) may perform the first boot-up procedure. For example, the boot-up procedure may use data stored by the memory system 110 in the training log during the training phase. That is, the boot-up procedure may be an example of a replay stage as described herein. In some examples, the memory system 110 may pre-load the boot sequence stored in the training log (e.g., data associated with the first set of write commands during the PBL, XBL, and UEFI stages), which may decrease latency associated with the boot-up procedure.

At 230, as part of the boot-up procedure (e.g., during the UEFI stage), a set of FUA commands may be received. For example, the memory system 110 may receive the set of FUA commands from the host system 105. In some examples, at least one FUA command of the set of FUA commands may include an indication that the at least one command is a FUA command (e.g., a FUA enabled bit).

At 235, data associated with the set of FUA commands may be written to volatile memory. For example, the memory system 110 (e.g., a memory system controller of the memory system) may write the data associated with the FUA commands to the volatile memory (e.g., a buffer, an SRAM buffer) of the memory system 110. That is, the memory system 110 may store the data in the volatile memory prior to executing the FUA commands and writing the data to the non-volatile memory. The memory system 110 may accordingly delay executing at least a portion of the FUA commands (e.g., by treating the FUA commands as non-FUA write commands).

In some examples, at 240, an acknowledgement may be provided in response to the FUA commands. For example, the memory system 110 (e.g., a memory system controller of the memory system) may provide a response to the host system 105. The memory system 110 may output a message to the host system 105 indicating that the memory system 110 has written the data to the non-volatile memory. In some examples, the memory system 110 may output the message prior to writing the data to the non-volatile memory. That is, the memory system 110 may indicate that the FUA commands are executed prior to executing the FUA commands (e.g., storing the data associated with the FUA commands to the non-volatile memory).

At 245, a trigger condition to write the data to the non-volatile memory may be satisfied. The memory system 110 (e.g., a memory system controller of the memory system) may identify that the trigger condition to write the data to the non-volatile memory is satisfied. The memory system 110 may write the data to the non-volatile memory (e.g., such that the data persists in a NAND of the memory system 110) in response to identifying the trigger condition being satisfied. In some examples, the memory system 110 may determine if the trigger condition is satisfied after writing the data to the volatile memory.

In some examples, the trigger condition may be associated with a quantity of FUA commands. For example, the memory system 110 may write the data to the non-volatile memory based on receiving a threshold quantity of FUA commands, or based on receiving a last FUA command of a set of FUA commands. In some examples, the memory system 110 may identify the last FUA command of the set of FUA commands based on the training log.

In some examples, at 250, an additional boot-up procedure of the system may be performed. For example, the memory system 110 (e.g., a memory system controller of the memory system) may perform an additional boot-up procedure. The additional boot-up procedure may occur following the training procedure. In some examples (e.g., as part of the additional boot-up procedure), at 255, the memory system 110 may receive an additional set of FUA commands from the host system 105. In some examples, at least one FUA command of the additional set of FUA commands may include an indication that the at least one command is a FUA command. In some examples, the additional set of FUA commands may be a subset of a larger set of FUA commands.

The memory system 110 may write data associated with the additional set of FUA commands to the volatile memory (e.g., a buffer) of the memory system 110. That is, the memory system 110 may store the data in the volatile memory prior to executing the FUA commands and writing the data to the non-volatile memory. The memory system 110 may accordingly delay executing at least a portion of the FUA commands.

In some examples, at 260, a power loss event may occur. The memory system 110 (e.g., a memory system controller of the memory system) may identify that the power loss event has occurred. In some examples, the memory system 110 may identify that the trigger condition to write the data to the non-volatile memory is satisfied prior to identifying the power loss event. The memory system 110 may accordingly write a subset of the data to the non-volatile memory in response to identifying the trigger condition being satisfied. In such examples, at 265, the memory system 110 may retrieve a subset of the first set of write commands associated with a subset of the set of logical addresses from the training log. For example, the memory system 110 may retrieve the subset of write commands that have been overwritten by writing the subset of the data to the non-volatile memory. The memory system 110 may accordingly use the retrieved write commands to perform the additional boot-up procedure.

Additionally, or alternatively, the memory system 110 may identify that the power loss event has occurred prior to identifying that the trigger condition is satisfied (e.g., prior to writing the data to the volatile memory). For example, if the power loss event occurs prior to receiving a second subset of the larger set of FUA commands, the memory system 110 may not write the data to the non-volatile memory. In such examples, at 265, the memory system 110 may retrieve the set of logical addresses (e.g., from the training log). The memory system 110 may accordingly retrieve the data stored in the logical addresses prior to the additional boot-up procedure (e.g., data from the training procedure), and may use the data stored in the logical addresses to perform the additional boot-up procedure. The power loss event may accordingly not impact a status of the data stored in the non-volatile memory (e.g., a NAND status), which may enable the memory system 110 to correctly perform a boot-up procedure (e.g., despite the power loss event).

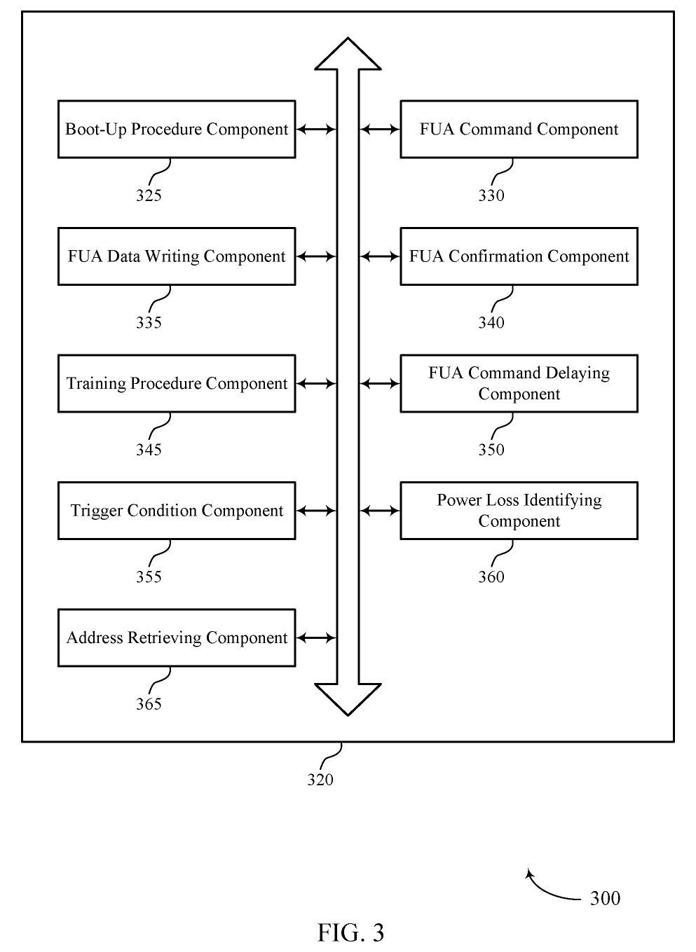

FIG. 3 shows a block diagram 300 of a memory system 320 that supports buffering FUA commands for boot-up procedures in accordance with examples as disclosed herein. The memory system 320 may be an example of aspects of a memory system as described with reference to FIGS. 1 through 2. The memory system 320, or various components thereof, may be an example of means for performing various aspects of buffering FUA commands for boot-up procedures as described herein. For example, the memory system 320 may include a boot-up procedure component 325, a FUA command component 330, a FUA data writing component 335, a FUA confirmation component 340, a training procedure component 345, a FUA command delaying component 350, a trigger condition component 355, a power loss identifying component 360, an address retrieving component 365, or any combination thereof. Each of these components, or components of subcomponents thereof (e.g., one or more processors, one or more memories), may communicate, directly or indirectly, with one another (e.g., via one or more buses).

The boot-up procedure component 325 may be configured as or otherwise support a means for performing a boot-up procedure associated with the memory system. To perform the boot-up procedure, the FUA command component 330 may be configured as or otherwise support a means for receiving a plurality of FUA write commands. The FUA data writing component 335 may be configured as or otherwise support a means for writing data associated with the plurality of FUA write commands in a volatile memory device of the memory system. In some examples, the FUA data writing component 335 may be configured as or otherwise support a means for writing the data associated with the plurality of FUA write commands in a non-volatile memory device of the memory system after a trigger condition is satisfied.

In some examples, the FUA confirmation component 340 may be configured as or otherwise support a means for transmitting an indication that the data associated with a first FUA write command of the plurality of FUA write commands is written to the non-volatile memory device before the data associated with the first FUA write command is written to the non-volatile memory device.

In some examples, the training procedure component 345 may be configured as or otherwise support a means for performing a training procedure associated with a second boot-up procedure that is before the boot-up procedure. To perform the training procedure, in some examples, the training procedure component 345 may be configured as or otherwise support a means for receiving a first set of write commands associated with a first set of logical addresses. In some examples, the training procedure component 345 may be configured as or otherwise support a means for writing data associated with the first set of write commands to the first set of logical addresses. In some examples, the training procedure component 345 may be configured as or otherwise support a means for writing the first set of write commands to a training log, where the trigger condition is based at least in part on the training log.

In some examples, the boot-up procedure component 325 may be configured as or otherwise support a means for performing a third boot-up procedure associated with the memory system. To perform the third boot-up procedure, in some examples, the FUA command component 330 may be configured as or otherwise support a means for receiving a first subset of a second plurality of FUA write commands. In some examples, the power loss identifying component 360 may be configured as or otherwise support a means for identifying a power loss event before receiving a second subset of the second plurality of FUA write commands. In some examples, the address retrieving component 365 may be configured as or otherwise support a means for retrieving, from the training log, the first set of logical addresses associated with the first set of write commands in accordance with the power loss event occurring before receiving the second subset.

In some examples, the boot-up procedure component 325 may be configured as or otherwise support a means for performing the third boot-up procedure using data stored in the first set of logical addresses associated the first set of write commands in response the power loss event occurring.

In some examples, the FUA command delaying component 350 may be configured as or otherwise support a means for delaying an execution of at least a portion of the plurality of FUA write commands based at least in part on writing the data in the volatile memory device.

In some examples, the trigger condition component 355 may be configured as or otherwise support a means for determining whether the trigger condition is satisfied after writing the data to the volatile memory device.

In some examples, the trigger condition component 355 may be configured as or otherwise support a means for determining that a last FUA write command of the plurality of FUA write commands is received, where the trigger condition includes receiving the last FUA write command.

In some examples, the trigger condition component 355 may be configured as or otherwise support a means for determining whether a quantity of the plurality of FUA write commands satisfies a threshold, where the trigger condition includes the quantity satisfying the threshold.

In some examples, at least one command of the plurality of FUA write commands includes an indication that the at least one command is a FUA command.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

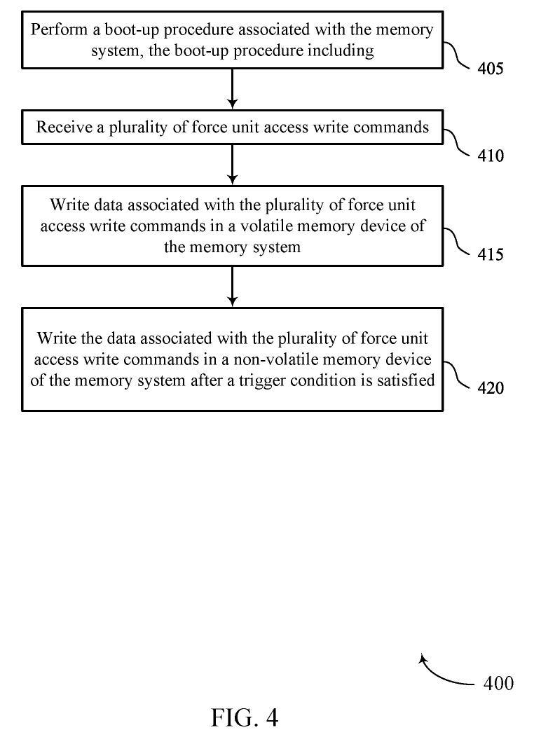

FIG. 4 shows a flowchart illustrating a method 400 that supports buffering FUA commands for boot-up procedures in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include performing a boot-up procedure associated with the memory system. In some examples, aspects of the operations of 405 may be performed by a boot-up procedure component 325 as described with reference to FIG. 3.

At 410, the method may include receiving a plurality of FUA write commands. In some examples, aspects of the operations of 410 may be performed by a FUA command component 330 as described with reference to FIG. 3.

At 415, the method may include writing data associated with the plurality of FUA write commands in a volatile memory device of the memory system. In some examples, aspects of the operations of 415 may be performed by a FUA data writing component 335 as described with reference to FIG. 3.

At 420, the method may include writing the data associated with the plurality of FUA write commands in a non-volatile memory device of the memory system after a trigger condition is satisfied. In some examples, aspects of the operations of 420 may be performed by a FUA data writing component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for performing a boot-up procedure associated with the memory system, the boot-up procedure including; receiving a plurality of FUA write commands; writing data associated with the plurality of FUA write commands in a volatile memory device of the memory system; and writing the data associated with the plurality of FUA write commands in a non-volatile memory device of the memory system after a trigger condition is satisfied.

Aspect 2: The method, apparatus, or non-transitory computer-readable medium of aspect 1, further including operations, features, circuitry, logic, means, or instructions, or any combination thereof for transmitting an indication that the data associated with a first FUA write command of the plurality of FUA write commands is written to the non-volatile memory device before the data associated with the first FUA write command is written to the non-volatile memory device.

Aspect 3: The method, apparatus, or non-transitory computer-readable medium of any of aspects 1 through 2, further including operations, features, circuitry, logic, means, or instructions, or any combination thereof for performing a training procedure associated with a second boot-up procedure that is before the boot-up procedure, where the training procedure includes; receiving a first set of write commands associated with a first set of logical addresses; writing data associated with the first set of write commands to the first set of logical addresses; and writing the first set of write commands to a training log, where the trigger condition is based at least in part on the training log.

Aspect 4: The method, apparatus, or non-transitory computer-readable medium of aspect 3, further including operations, features, circuitry, logic, means, or instructions, or any combination thereof for performing a third boot-up procedure associated with the memory system, where the third boot-up procedure includes; receiving a first subset of a second plurality of FUA write commands; identifying a power loss event before receiving a second subset of the second plurality of FUA write commands; and retrieving, from the training log, the first set of logical addresses associated with the first set of write commands in accordance with the power loss event occurring before receiving the second subset.

Aspect 5: The method, apparatus, or non-transitory computer-readable medium of aspect 4, further including operations, features, circuitry, logic, means, or instructions, or any combination thereof for performing the third boot-up procedure using data stored in the first set of logical addresses associated the first set of write commands in response the power loss event occurring.

Aspect 6: The method, apparatus, or non-transitory computer-readable medium of any of aspects 1 through 5, further including operations, features, circuitry, logic, means, or instructions, or any combination thereof for delaying an execution of at least a portion of the plurality of FUA write commands based at least in part on writing the data in the volatile memory device.

Aspect 7: The method, apparatus, or non-transitory computer-readable medium of any of aspects 1 through 6, further including operations, features, circuitry, logic, means, or instructions, or any combination thereof for determining whether the trigger condition is satisfied after writing the data to the volatile memory device.

Aspect 8: The method, apparatus, or non-transitory computer-readable medium of aspect 7, further including operations, features, circuitry, logic, means, or instructions, or any combination thereof for determining that a last FUA write command of the plurality of FUA write commands is received, where the trigger condition includes receiving the last FUA write command.

Aspect 9: The method, apparatus, or non-transitory computer-readable medium of any of aspects 7 through 8, further including operations, features, circuitry, logic, means, or instructions, or any combination thereof for determining whether a quantity of the plurality of FUA write commands satisfies a threshold, where the trigger condition includes the quantity satisfying the threshold.

Aspect 10: The method, apparatus, or non-transitory computer-readable medium of any of aspects 1 through 9, where at least one command of the plurality of FUA write commands includes an indication that the at least one command is a FUA command.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
perform a boot-up procedure associated with the memory system, wherein, to perform the boot-up procedure, the processing circuitry is further configured to cause the memory system to:
receive a plurality of force unit access write commands;
write data associated with the plurality of force unit access write commands in a volatile memory device of the memory system; and
write the data associated with the plurality of force unit access write commands in a non-volatile memory device of the memory system after a trigger condition is satisfied.

2. The memory system of claim 1, wherein the processing circuitry is further configured to cause the memory system to transmit an indication that the data associated with a first force unit access write command of the plurality of force unit access write commands is written to the non-volatile memory device before the data associated with the first force unit access write command is written to the non-volatile memory device.

3. The memory system of claim 1, wherein the processing circuitry is further configured to cause the memory system to:
perform a training procedure associated with a second boot-up procedure that is before the boot-up procedure, wherein, to perform the training procedure, the processing circuitry is further configured to cause the memory system to:
receive a first set of write commands associated with a first set of logical addresses;
write data associated with the first set of write commands to the first set of logical addresses; and
write the first set of write commands to a training log, wherein the trigger condition is based at least in part on the training log.

4. The memory system of claim 3, wherein the processing circuitry is further configured to cause the memory system to:
perform a third boot-up procedure associated with the memory system, wherein, to perform the third boot-up procedure, the processing circuitry is further configured to cause the memory system to:
receive a first subset of a second plurality of force unit access write commands;
identify a power loss event before receiving a second subset of the second plurality of force unit access write commands; and
retrieve, from the training log, the first set of logical addresses associated with the first set of write commands in accordance with the power loss event occurring before receiving the second subset.

5. The memory system of claim 4, wherein the processing circuitry is further configured to cause the memory system to perform the third boot-up procedure using data stored in the first set of logical addresses associated the first set of write commands in response the power loss event occurring.

6. The memory system of claim 1, wherein the processing circuitry is further configured to cause the memory system to delay an execution of at least a portion of the plurality of force unit access write commands based at least in part on writing the data in the volatile memory device.

7. The memory system of claim 1, wherein the processing circuitry is further configured to cause the memory system to determine whether the trigger condition is satisfied after writing the data to the volatile memory device.

8. The memory system of claim 7, wherein the processing circuitry is further configured to cause the memory system to determine that a last force unit access write command of the plurality of force unit access write commands is received, wherein the trigger condition comprises receiving the last force unit access write command.

9. The memory system of claim 7, wherein the processing circuitry is further configured to cause the memory system to determine whether a quantity of the plurality of force unit access write commands satisfies a threshold, wherein the trigger condition comprises the quantity satisfying the threshold.

10. The memory system of claim 1, wherein at least one command of the plurality of force unit access write commands includes an indication that the at least one command is a force unit access command.

11. A non-transitory computer-readable medium storing code comprising instructions which, when executed by processing circuitry of a memory system, cause the memory system to:
perform a boot-up procedure associated with the memory system, wherein, to perform the boot-up procedure, the instructions are further executable to cause the memory system to:
receive a plurality of force unit access write commands;
write data associated with the plurality of force unit access write commands in a volatile memory device of the memory system; and
write the data associated with the plurality of force unit access write commands in a non-volatile memory device of the memory system after a trigger condition is satisfied.

12. The non-transitory computer-readable medium of claim 11, wherein the instructions, when executed by the processing circuitry of the memory system, further cause the memory system to:
transmit an indication that the data associated with a first force unit access write command of the plurality of force unit access write commands is written to the non-volatile memory device before the data associated with the first force unit access write command is written to the non-volatile memory device.

13. The non-transitory computer-readable medium of claim 11, wherein the instructions, when executed by the processing circuitry of the memory system, further cause the memory system to:
perform a training procedure associated with a second boot-up procedure that is before the boot-up procedure, wherein, to perform the training procedure, the instructions are further executable to cause the memory system to:
receive a first set of write commands associated with a first set of logical addresses;
write data associated with the first set of write commands to the first set of logical addresses; and
write the first set of write commands to a training log, wherein the trigger condition is based at least in part on the training log.

14. The non-transitory computer-readable medium of claim 13, wherein the instructions, when executed by the processing circuitry of the memory system, further cause the memory system to:
perform a third boot-up procedure associated with the memory system, wherein, to perform the third boot-up procedure, the instructions are further executable to cause the memory system to:
receive a first subset of a second plurality of force unit access write commands;
identify a power loss event before receiving a second subset of the second plurality of force unit access write commands; and
retrieve, from the training log, the first set of logical addresses associated with the first set of write commands in accordance with the power loss event occurring before receiving the second subset.

15. The non-transitory computer-readable medium of claim 14, wherein the instructions, when executed by the processing circuitry of the memory system, further cause the memory system to:
perform the third boot-up procedure using data stored in the first set of logical addresses associated the first set of write commands in response the power loss event occurring.

16. The non-transitory computer-readable medium of claim 11, wherein the instructions, when executed by the processing circuitry of the memory system, further cause the memory system to:
delay an execution of at least a portion of the plurality of force unit access write commands based at least in part on writing the data in the volatile memory device.

17. The non-transitory computer-readable medium of claim 11, wherein the instructions, when executed by the processing circuitry of the memory system, further cause the memory system to:
determine whether the trigger condition is satisfied after writing the data to the volatile memory device.

18. The non-transitory computer-readable medium of claim 17, wherein the instructions, when executed by the processing circuitry of the memory system, further cause the memory system to:
determine that a last force unit access write command of the plurality of force unit access write commands is received, wherein the trigger condition comprises receiving the last force unit access write command.

19. The non-transitory computer-readable medium of claim 17, wherein the instructions, when executed by the processing circuitry of the memory system, further cause the memory system to:
determine whether a quantity of the plurality of force unit access write commands satisfies a threshold, wherein the trigger condition comprises the quantity satisfying the threshold.

20. The non-transitory computer-readable medium of claim 11, wherein at least one command of the plurality of force unit access write commands includes an indication that the at least one command is a force unit access command.

21. A method at a memory system, comprising:
performing a boot-up procedure associated with the memory system, the boot-up procedure comprising:
receiving a plurality of force unit access write commands;
writing data associated with the plurality of force unit access write commands in a volatile memory device of the memory system; and
writing the data associated with the plurality of force unit access write commands in a non-volatile memory device of the memory system after a trigger condition is satisfied.

22. The method of claim 21, further comprising:
transmitting an indication that the data associated with a first force unit access write command of the plurality of force unit access write commands is written to the non-volatile memory device before the data associated with the first force unit access write command is written to the non-volatile memory device.
